(19) United States
(12) Patent Application Publication
(10) Pub. No.: US 2021/0291658 A1
(43) Pub. Date: Sep. 23, 2021

(54) INFORMATION DISPLAY APPARATUS AND INFORMATION DISPLAYING METHOD

(71) Applicant: Maxell, Ltd., Kyoto (JP)

(72) Inventors: Koji HIRATA, Kyoto (JP); Masahiko YATSU, Kyoto (JP); Chohei ONO, Kyoto (JP); Masayuki FUKUI, Kyoto (JP); Yasuhiko KUNII, Kyoto (JP); Akio MISAWA, Kyoto (JP); Kanei KAKU, Kyoto (JP)

(73) Assignee: Maxell, Ltd., Kyoto (JP)

(21) Appl. No.: 17/264,314

(22) PCT Filed: Jul. 18, 2019
(86) PCT No.: PCT/JP2019/028350

§ 371 Date: Jan. 29, 2021

(30) Foreign Application Priority Data
Jul. 31, 2018 (JP) 2018-143187

(51) Int. Cl. B60K 35/00; G02B 27/01; G02B 27/00; G02B 5/10

(52) U.S. Cl. CPC B60K 35/00; G02B 27/0101; G02B 27/0093; G02B 2027/011; B60K 2370/1529; B60K 2370/31; B60K 2370/785; G02B 5/10

(57) ABSTRACT

An information display apparatus is provided. The information display apparatus includes: a display configured to display video information of a virtual image; and a virtual image optical system configured to display a virtual image at a front of conveyance by reflecting light emitted from the display. The system includes a concave mirror and an optical element. The optical element is arranged between the display and the concave mirror, and is configured to correct distortion of the virtual image obtained in accordance with a viewpoint position of a driver. The information display apparatus further includes means for forming the virtual image generated by reflecting a video light flux by means of front and back surfaces of the windshield in front of a position of a driver's line of sight in a region where a virtual image distance exceeds a driver's determination limit range or a region around the determination limit range.

### TECHNICAL FIELD

The present invention relates to an information display apparatus and an information displaying method, which project an image on a windshield (hereinafter, also called as a “window glass” or a “windscreen”) of a vehicle, an electric train, an airplane, or the like (hereinafter, generally referred to as a “conveyance”). In particular, the present invention relates to a projection optical system, in which an image is observed through the windshield as a virtual image, an information display apparatus and an information displaying method using the projection optical system.

### BACKGROUND ART

A so-called head up display (HUD: Head Up Display) apparatus has already been known by Patent Document 1 below. The head up display apparatus projects video light onto a windshield or a combiner of a vehicle to form a virtual image, thereby displaying traffic information such as route information or traffic jam information and vehicle information such as a remaining amount of fuel or cooling water temperature thereon.

In this type of information display apparatus, it is desired that a region that a driver can view a virtual image is enlarged. However, it is an important performance factor that a virtual image has high resolution and high visibility.

A head up display apparatus necessarily requires a windshield or combiner as a final reflecting surface by which a virtual image is provided to a driver. The inventors of the present application noticed that improvement of a double image of a virtual image, which is generated by double reflection that occurs on the windshield or combiner as the final reflecting surface, was important in order to obtain good resolution performance with high visibility.

As a countermeasure against this, as illustrated in FIG. 17, it was conventionally designed so that a cross section of a front windshield forms an interlayer 6b with a wedge shape and an optical path of light reflected by an inner surface (a front surface) of the windshield and an optical path of light reflected by a surface in contact with the outside world (a back surface) become one optical path to reach eyes of a driver.

On the other hand, for example, an apparatus whose body including a combiner is attached to the vicinity of a ceiling (or a sun visor) of a vehicle has already been proposed.

### RELATED ART DOCUMENTS

### Patent Documents

Patent document 1: Japanese Patent Application Publication No. 2015-194707

### SUMMARY OF THE INVENTION

### Problems to be Solved by the Invention

As illustrated in FIG. 18, a principle of generation of a virtual image by a concave mirror to realize a head up display apparatus according to a conventional technique arranges an object point AB at an inner side of a focal point F (a focal point distance f) with respect to a point O on an optical axis of a concave mirror 1′, thereby allowing the virtual image by the concave mirror 1′ to be obtained. In FIG. 18, for convenience of explanation, the concave mirror 1′ is regarded as a convex lens with the same positive refractive power, and a relationship among an object point, the convex lens (described by the concave mirror in FIG. 18 for convenience of explanation), and the virtual image to be generated is illustrated.

In the conventional technique, in order to enlarge a size of the virtual image to be generated on the concave mirror 1′, the object point AB may be caused to approach the focal point F and the concave mirror may be enlarged with respect to an object size AB. However, in order to obtain desired magnification, a radius of curvature of the concave mirror becomes smaller. Thus, it is difficult to establish both of these. As a result, a mirror size becomes smaller, and this results in a state where only a virtual image whose magnification power is effectively large but a viewable range is small can be obtained. For this reason, in order to satisfy (1) a desired size of a virtual image, and (2) necessary magnification of the virtual image M=b/a at the same time, it is necessary that a dimension of the concave mirror is fitted to a viewing range and magnification of the virtual image is determined in view of a video display apparatus.

For this reason, in the conventional technique, in order to obtain a large virtual image in a desired view range, for example, as illustrated in FIG. 18, a distance from the concave mirror 1′ to a virtual image needed to be enlarged. Namely, there was necessary that a distance between the windshield or combiner (not illustrated in the drawings) as the final reflecting surface and the concave mirror is to be enlarged and a size of the concave mirror is to be enlarged at the same time. However, in the conventional technique, a double image of a virtual image generated by double reflection that occurs on a front surface and a back surface of glass in a windshield or combiner has never been considered.

Further, for example, in the example of the head up display apparatus disclosed in Patent Document 1 described above, which is the conventional technique, the head up display apparatus includes a device configured to display an image and a projection optical system configured to project the image displayed by the display device. The projection optical system includes a first mirror and a second mirror on an optical path of a viewer from the display device. Miniaturization is realized by satisfying predetermined conditions for a relationship among an incident angle of the first mirror in a long axis direction of the image, an incident angle of the first mirror in a short axis direction of the image, an interval between an image display surface of the display device and the first mirror, and a width of a virtual image viewed and recognized by the viewer in a horizontal direction. However, means for reducing the double image described above, which is generated by reflection of both surfaces of a windshield (two surfaces at a driver's side and an outside) is not described in Patent document 1.

On the other hand, in an apparatus whose body is attached to the vicinity of a ceiling (or a sun visor) of a vehicle, generation of a double image is reduced by forming antireflection coating on a reflecting surface to which a driver does not face. However, problems on safety still remains such as a possibility that a driver may get an injury in a case where a collision accident occurs and an HUD apparatus thereby comes off.

For this reason, it is thought that a system in which a windshield is used as a reflecting surface disclosed in Patent document 1 described above becomes mainstream in the future. Therefore, technical means for reducing a situation that virtual images formed by video light, which are reflected by both surfaces of a windshield, overlap to become a double image by means of contrivance of a projection optical system has been invented.

Moreover, a windshield in which an interlayer whose cross section is a wedge shape is formed between two sheets of glass becomes relatively expensive due to manufacturing processes thereof. Therefore, it lacked economic efficiency and generality.

It is thus an object of the present invention to provide an information display apparatus capable of observing an image as a virtual image through a windshield and an image displaying method therefor, and in particular, to provide an information display apparatus and an image displaying method therefor capable of reducing deterioration of visibility due to double image conversion of a virtual image, which is generated in a case where a normal windshield is used as a reflecting surface to a level at which there is no practical problem to form the virtual image.

### Means for Solving the Problem

As the present invention that has been made in order to achieve the object described above, as one example, an information display apparatus configured to display video information of a virtual image on a windshield of conveyance and an information displaying method therefor are provided. The information display apparatus includes: a display configured to display the video information; and a virtual image optical system configured to display a virtual image at a front of the conveyance by reflecting light emitted from the display by means of the windshield. The virtual image optical system includes a concave mirror and an optical element. The optical element is arranged between the display and the concave mirror, and is configured to correct distortion of the virtual image obtained in accordance with a viewpoint position of a driver on a basis of a shape of the concave mirror and a shape of the optical element. The information display apparatus or the information displaying method further includes means or a step for forming the virtual image generated by reflecting a video light flux by means of a front surface and a back surface of the windshield in front of a position of a line of sight of the driver in a region in which a virtual image distance exceeds a determination limit range of the driver or a visual field distance region around the determination limit range.

### Effects of the Invention

According to the information display apparatus of the present invention, an excellent practical effect is exerted that by optimizing the shape and the arrangement of the optical element in accordance with the video light flux that establishes the respective virtual images separated between the display and the concave mirror and making it possible to reduce the double image conversion of the virtual image, which is generated by reflecting the video light flux by means of the front surface and the back surface of the general windshield, to the level at which there is no practical problem while adopting the general windshield, it becomes possible to provide an economically and generally excellent information display apparatus that respectively forms a plurality of virtual images at a plurality of positions in accordance with the viewpoint position of the driver while maintaining a small size.

### BRIEF DESCRIPTIONS OF THE DRAWINGS

FIG. 1 is a schematic configuration diagram illustrating an information display apparatus according to an embodiment of the present invention and a peripheral equipment thereof;

FIG. 2 is a top view of a vehicle on which the information display apparatus is mounted;

FIG. 3 is a view for explaining a difference of a radius of curvature of a windshield;

FIG. 4 is a schematic configuration diagram illustrating one embodiment of an optical system for a virtual image displayed far away of the information display apparatus;

FIG. 5 is a schematic configuration diagram illustrating one embodiment of an optical system for a virtual image displayed at a short distance of the information display apparatus;

FIG. 6 is a schematic view for explaining a principle of generation of a double image;

FIG. 7 is a schematic view for explaining a virtual image that a driver visually recognizes by the double image;

FIG. 8 is a schematic configuration diagram illustrating the information display apparatus, the windshield, and viewpoint position of the driver, and illustrating generation of the double image;

FIG. 9 is a characteristic diagram illustrating a result obtained by simulating a shift amount between a virtual image distance and the double image;

FIG. 10 is a configuration diagram illustrating arrangement of a video display apparatus and a light source apparatus;

FIG. 11 is a schematic configuration diagram illustrating a configuration of the light source apparatus;

FIG. 12 is a schematic view for explaining an emission status of a light flux from the video display apparatus and the light source apparatus;

FIG. 13 is a characteristic diagram for explaining emission light distribution of the light flux from the light source apparatus;

FIG. 14 is a structural drawing of a light guide element that constitutes backlight of a liquid crystal panel;

FIG. 15 is a detail drawing illustrating a structure of the light guide element that constitutes the backlight of the liquid crystal panel;

FIG. 16 is a schematic view for explaining a change in a reflection factor of glass due to an incident angle by S-polarized light and P-polarized light;

FIG. 17 is an explanatory diagram for explaining a conventional technique that reduces a double image generated in a virtual image; and

FIG. 18 is a schematic view for explaining a principle of a virtual image optical system by the conventional technique.

### DETAILED DESCRIPTION OF EMBODIMENTS

Hereinafter, embodiments of the present invention will be described in detail with reference to the drawings and the like. Note that the present invention is not limited to the following explanation, and various changes and modifications can be made by a person having ordinary skill in the art within a scope of technical ideas disclosed in the present specification. Further, in all of the drawings for explaining the present invention, the same reference numeral may be attached to a component having the same function, and repeated explanation may be omitted.

<Embodiment of Information Display Apparatus>

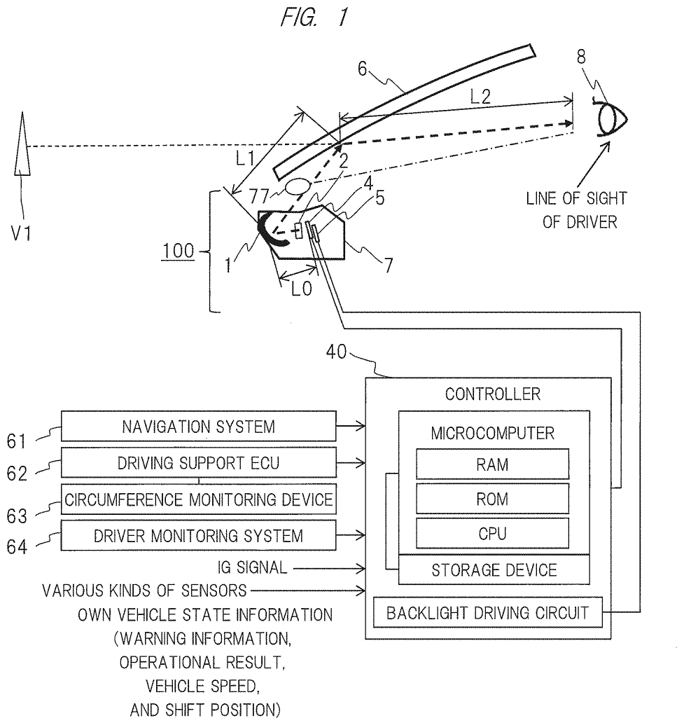

FIG. 1 is a block diagram and a schematic configuration diagram illustrating a peripheral equipment configuration of an information display apparatus according to one embodiment of the present invention. Here, an information display apparatus 100 configured to project an image onto a windshield of a vehicle will be described particularly as one example thereof.

This information display apparatus 100 is an apparatus (that is, a so-called HUD (Head Up Display)) configured to display, as a virtual image VI (Virtual Image), various kinds of information that are reflected by a projected member 6 (in the present embodiment, an inner surface of the windshield) in order to form a virtual image V1 at a front side of an own vehicle along a line of sight 8 of a driver. Note that the projected member 6 may be a member on which information is projected, and as the most preferable example, a windshield with a structure that is generally adopted in a vehicle can be cited unlike the windshield in which an interlayer whose cross section is a wedge shape is formed between the two sheets of glass described above. Note that otherwise, it may be a combiner. Namely, in the information display apparatus 100 according to the present embodiment, the projected member 6 may be a member that allows the driver to view (and recognize) a virtual image that is formed at the front side of the own vehicle along the line of sight 8 the driver. As a matter of course, vehicle information, and information on the foreground photographed by cameras (not illustrated in the drawings), such as a monitoring camera or an around viewer, are contained as the information to be displayed as the virtual image, for example.

Further, the information display apparatus 100 includes a video display apparatus 4, a concave mirror 1, and a group of lenses 2 for correction provided between the video display apparatus 4 and the concave mirror 1. The video display apparatus 4 is configured to project video light to display information. The group of lenses 2 is configured to correct distortion and/or aberration that occurs when a virtual image is formed by a concave mirror 1 from video displayed by the video display apparatus 4.

The information display apparatus 100 also includes a controller 40 configured to control the video display apparatus 4 described above and a backlight 5. Note that optical components including the video display apparatus 4 and the backlight 5 described above is a virtual image optical system, which will be described later, and includes the mirror concave 1, which reflects light. Further, the light reflected by these optical components is reflected by the projected member 6 to go toward the line of sight 8 of the driver (EyeBox: which will be described later).

As the video display apparatus 4 described above, for example, there are a light emitting VFD (Vacuum Fluorescent Display) and the like in addition to an LCD (Liquid Crystal Display) having a backlight.

On the other hand, in place of the video display apparatus 4 described above, video may be displayed on a screen by a projection apparatus, a virtual image may be formed therefrom by the concave mirror 1 described above and reflected by a windshield 6 that is the projected member to direct to the line of sight 8 of the driver.

As such a screen, for example, the screen may be configured by a microlens array in which microlenses are arranged thereon in a two-dimensional manner.

Here, in order to reduce distortion of the virtual image, a shape of the concave mirror 1 may have a shape in which a radius of curvature at an upper portion of a general windshield 6 illustrated in FIG. 1 (that is, an area where a ray is reflected at a lower part of the windshield 6 at which a distance from a viewpoint of the driver is relatively short) so that magnification power thereof becomes larger is relatively small, and a radius of curvature at a lower portion thereof (that is, an area where a ray is reflected at an upper part of the windshield 6 at which a distance from the viewpoint of the driver is relatively long) so that magnification power thereof becomes smaller is relatively large. Further, a difference of virtual image magnifications described above is corrected by inclining the video display apparatus 4 with respect to an optical axis of the concave mirror to reduce distortion itself that may occur, whereby good correction can further be realized.

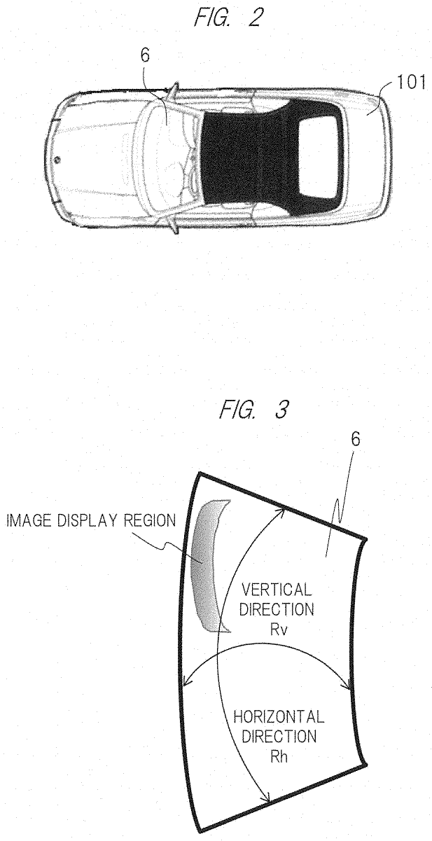

On the other hand, as illustrated in FIG. 2 and FIG. 3, with respect to the windshield 6 of the vehicle, a radius of curvature Rv in a vertical direction of a body thereof is different from a radius of curvature Rh in a horizontal direction, and they generally have a relationship of Rh>Rv. For this reason, when the windshield 6 is grasped as a reflecting surface, it becomes a toroidal surface of the concave mirror. For this reason, in the information display apparatus 100 of the present embodiment, the shape of the concave mirror 1 may have different average radii of curvature between the horizontal direction and the vertical direction so as to correct the virtual image magnification by a shape of the windshield 6, that is, so as to correct a difference between the radii of curvature in the vertical direction and the horizontal direction of the windshield 6. In this case, in a case where the shape of the concave mirror 1 is a spherical or aspherical shape symmetric about the optical axis (that is, a shape expressed by Formula 2, which will be described later), it becomes a function of a distance r from the optical axis, a horizontal cross-sectional shape and a vertical cross-sectional shape of separated places cannot be controlled individually. Therefore, it is preferable to correct the difference as a function of a coordinate (x, y) on a surface from the optical axis of a mirror surface as a free-form surface expressed by Formula 1 (will be described later).

The explanation returns to FIG. 1 again. An optical element 2 (a lens element) is further arranged between the video display apparatus 4 and the concave mirror 1 as a transmissive optical component, for example. By controlling an emission direction of the ray to the concave mirror 1, aberration correction of the virtual image including astigmatism that occurs due to the difference between the radius of curvature in the horizontal direction and the radius of curvature in the vertical direction of the windshield 6 described above is realized at the same time as correction of distortion aberration is carried out in accordance with the shape of the concave mirror 1.

Further, in order to further heighten aberration correction capability, an optical element 2 as described above may be constituted by a plurality of lenses. Alternatively, by arranging a curved mirror in place of the lens element and controlling an incident position of the ray to the concave mirror 1 at the same time of folding of the optical path, it is possible to reduce distortion aberration. As described above, it goes without saying that it does not depart from technical ideas or a range of the present invention even though an optical element optimally designed to improve the aberration correction capability is further provided between the concave mirror 1 and the video display apparatus 4. Moreover, by changing a thickness of the optical element 2 described above in an optical axis direction, an optical distance between the concave mirror 1 and the video display apparatus 4 can be changed in addition to true aberration correction, whereby it is possible to continuously change a display position of the virtual image from a distant place to an adjacent position.

Further, by arranging the video display apparatus 4 so as to incline the same with respect to a normal line of the optical axis of the concave mirror 1, the difference of magnifications of the virtual image in the vertical direction may be corrected.

On the other hand, as a factor to deteriorate image quality of the information display apparatus 100, there is known a fact that a video light ray emitted from the video display apparatus 4 toward the concave mirror 1 is reflected by a surface of the optical element 2 arranged in the middle to return to the video display apparatus 4, and is then reflected again to be superimposed on true video light, whereby the image quality thereof is deteriorated. For this reason, in the present embodiment, it is preferable that the information display apparatus 100 is designed so that not only antireflection coating is formed on the surface of the optical element 2 to suppress the reflection, but also a lens surface shape of any one or both of an incident surface and an emission surface of the optical element 2 for the video light is caused to have restriction for the surface shape to become a shape so that the reflected light described above does not focus on a part of the video display apparatus 4 (for example, a shape in which a concave surface faces the video display apparatus 4).

Next, in a case where, as the video display apparatus 4, a second polarizing plate is arranged so as to be separated from a liquid crystal panel in addition to a first polarizing plate arranges in proximity to the liquid crystal panel in order to absorb the reflected light from the optical element 2 described above, it is possible to reduce deterioration in image quality. Further, the backlight 5 of the liquid crystal panel is controlled so that an incident direction of light incident on the liquid crystal panel 4 efficiently enters an incident eye of the concave mirror 1. At this time, by making a divergent angle of a light flux incident on the liquid crystal panel smaller, it becomes possible to effectively direct video light toward eye points of the driver. In a case where a liquid crystal display element is used as a video source, contrast performance in the horizontal direction with respect to the divergent angle of the video is remarkable. When a visual angle is within ±20°, an excellent property can be obtained. In order to further improve the contrast performance, a light flux whose visual angle is within ±10° may be used.

On the other hand, it is preferable that a solid light source with long product lifetime is adopted as the light source. Moreover, it is preferable that polarization conversion is further carried out by using a PBS (Polarizing Beam Splitter) in which optical means for reducing a divergent angle of light as LED (Light Emitting Diode) whose change in light output with respect to variation in ambient temperature is small is provided.

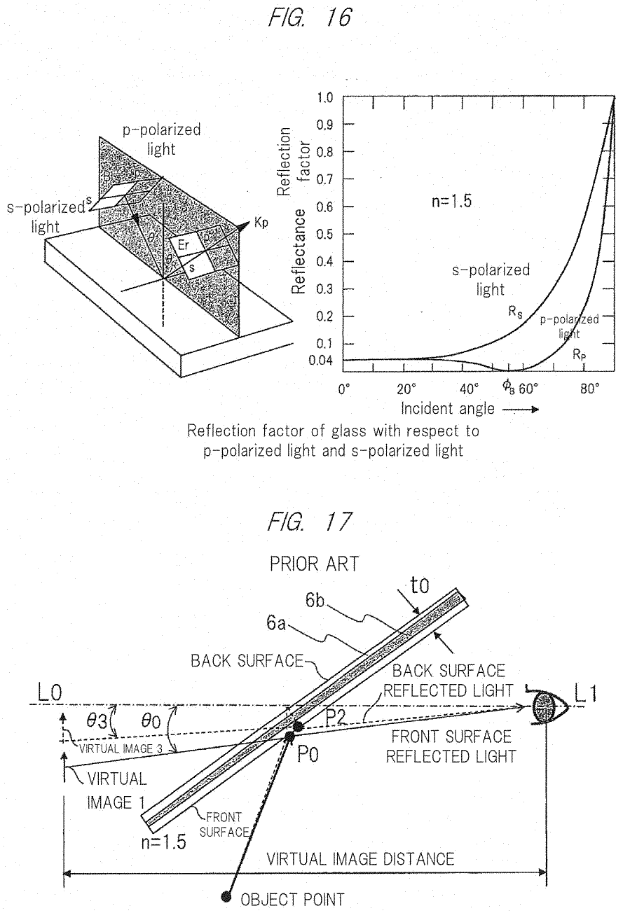

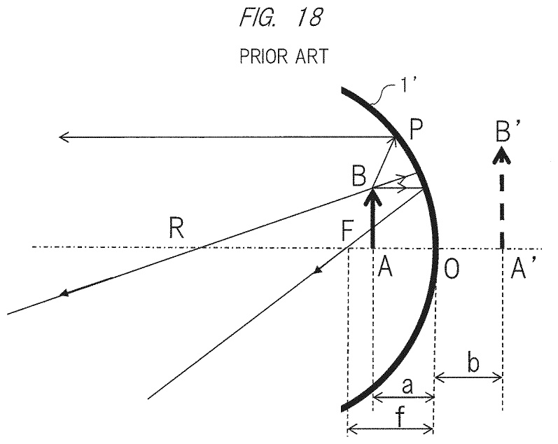

Polarizing plates are respectively arranged at the backlight 5 side (light incident surface) and the optical element 2 side (light emission surface) of the liquid crystal panel. This makes it possible to heighten a contrast ratio of the video light (in particular, it is important to improve efficiency of reflection by a windshield in order to ensure brightness of the virtual image, and in consideration of this point, it is preferable that s-polarized light is used as the video light: see FIG. 16). In a case where iodine-based one in which the degree of polarization is high is adopted for the polarizing plate provided at the backlight 5 side (light incident surface), a high contrast ratio can be obtained. On the other hand, by using a dye-based polarizing plate for one provided at the optical element 2 side (light emission surface), it becomes possible to obtain high reliability even in a case where outside light enters or ambient temperature is high.

In a case where the liquid crystal panel is used as the video display apparatus 4, in particular, in a case where the driver wears polarized sunglasses in such a situation, a specific polarized wave is blocked or shielded, whereby a defect in which video cannot be viewed occurs. In order to prevent this situation, it is preferable that a λ/4 plate is arranged at a side of the optical element of the polarizing plate that is arranged at the optical element 2 side of the liquid crystal panel, whereby the video light uniformed to a specific polarization direction is converted into circular polarized light.

The controller 40 obtains, from such a navigation system 61, various kinds of information such as a speed limit and the number of lanes of a road corresponding to a current position at which the own vehicle is travelling, and a scheduled movement route of the own vehicle set to the navigation system 61 as foreground information (that is, information to be displayed at a front of the own vehicle by the virtual image described above).

A driving support ECU 62 is a controller that realizes driving support control by controlling a drive system and a control system in accordance with an obstacle detected as a result of monitoring by a circumference monitoring device 63. The driving support control includes well-known technologies such as cruise control, adaptive cruise control, pre-crush safety, lane keeping assist, for example.

The circumference monitoring device 63 is a device for monitoring a status of a circumference of the own vehicle. As one example, there are a camera that detects an object existing on the circumference of the own vehicle on the basis of an image obtained by photographing the circumference of the own vehicle, an exploratory device that detects an object existing around the own vehicle on the basis of a result obtained by transmitting and receiving an exploratory wave, and the like.

A driver monitoring system 64 executes support for safe driving by monitoring facial expression of the driver while driving by a camera 77 installed in front of a driver's seat, determining whether there is any problem in driving such as a health status or a mental condition or not, and causing the driving support ECU 62 to control driving of the own vehicle on the basis of a result thereof. Further, in order to detect the health status of the driver, sensors for respectively detecting a pulse, a respiratory rate, and body temperature may be provided in the driver's seat (not illustrated in the drawings), and similar sensing functions can also be obtained by software processing through the camera 77 described above. Moreover, by detecting drowsiness and the like as well, high accurate support for safe driving can be realized. In addition, it can be used as means for detecting a position of a line of sight of the driver in order to display video of the HUD at the optimal position.

The controller 40 obtains such information from the driving support ECU 62 (for example, a distance to a preceding vehicle and a direction of the preceding vehicle, a position at which an obstacle or a traffic sign exists, and the like) as foreground information. Moreover, an ignition (IG) signal and own vehicle state information are inputted to the controller 40. The own vehicle state information among these kinds of information is information obtained as the vehicle information. For example, the own vehicle state information contains warning information indicating to become an abnormal state defined in advance, such as residual quantity of fuel for an internal-combustion engine or temperature of cooling water. Further, the own vehicle state information also contains an operational result of a direction indicator, travelling speed of the own vehicle, and shift position information. The controller 40 that has been mentioned above is activated when the ignition signal is inputted thereto. As the above, the whole system of the information display apparatus according to the present embodiment has been described.

<First Embodiment of Virtual Image Optical System>

Next, further details of a virtual image optical system according to the present embodiment and the video display apparatus will be described below.

As have already been mentioned above, FIG. 2 is a top view of the vehicle on which the information display apparatus 100 according to the present embodiment is mounted. A windshield exists as the projected member 6 in front of a driver's seat of a vehicle body 101. Note that an inclination angle of this windshield with respect to the vehicle body is different depending upon a type of the vehicle. Moreover, the inventors of the present application researched this radius of curvature in order to realize an optimum virtual image optical system. As a result, as illustrated in FIG. 3, the inventors found that in the windshield, the radius of curvature Rh in the horizontal direction parallel to a contact surface of the vehicle is different from the radius of curvature Rv in the vertical direction orthogonal with respect to a horizontal axis, and there is generally a relationship below between Rh and Rv.

Rh>Rv

Further, it was also found that most of vehicles has this difference between the radii of curvature, that is, the Rh with respect to Rv in a range from 1.5 times to 2.5 times.

Next, the inventors also researched commercial products with respect to an inclination angle of the windshield. As a result, although it is different depending upon a vehicle body type, it was 20° to 30° in a light motor vehicle or a minivan type, 30° to 40° in a sedan type, and 40° or more in a sports type. Thus, in the present embodiment, a difference between the radius of curvature Rh in the horizontal direction of the windshield parallel to the contact surface of the vehicle and the radius of curvature Rv in the vertical direction orthogonal to the horizontal axis and the inclination angle of the windshield were considered to design the virtual image optical system.

More specifically, since the horizontal radius of curvature Rh and the vertical radius of curvature Rv of the windshield that is the projected member are greatly different from each other, good aberration correction was realized by providing the optical element 2 in the virtual image optical system. The optical element 2 is axially asymmetric with the horizontal axis of the windshield with respect to the optical axis (Z axis) and the axis vertical to this axis.

<Mechanism of Occurrence of Double Image Conversion of Virtual Image>

As a result of various kinds of investigation, the inventors developed a technique to reduce double image conversion of a virtual image, which will be described below in detail, on the basis of knowledge mentioned below.

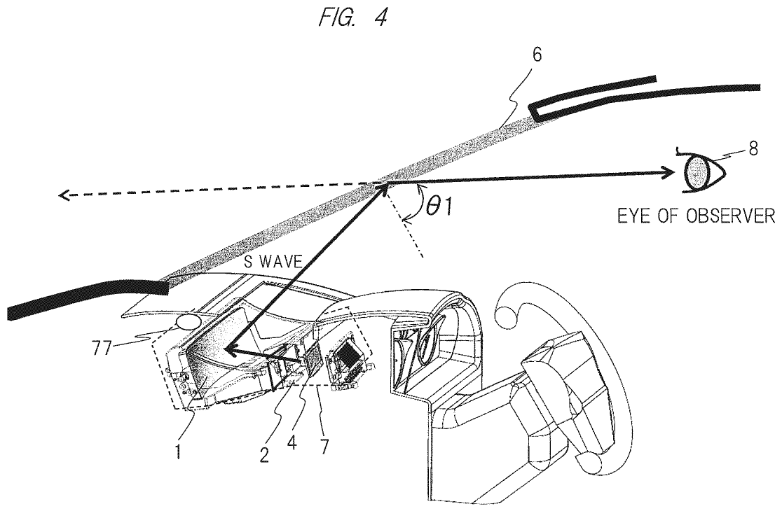

FIG. 4 is a view illustrating a state in a case where an image forming position of a virtual image is directed toward far away from the driver. Since the line of sight of the driver viewing the virtual image goes far away, an angle 91 at which video light is reflected on the windshield becomes smaller.

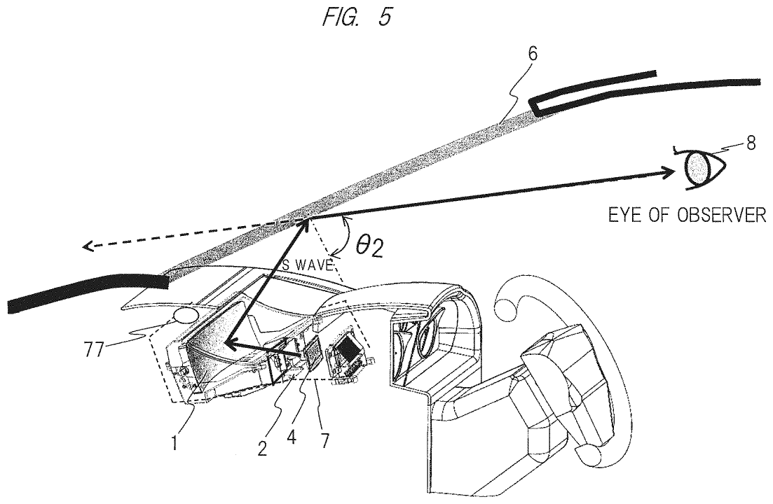

On the other hand, as illustrated in FIG. 5, the line of sight of the driver viewing the virtual image is directed toward the front in a state where the image forming position of the virtual image is set to a short distance close to the driver. Therefore, an angle 92 at which video light is reflected on the windshield becomes larger compared with the angle θ1 described above. The inventors have developed a technique to reduce the double image conversion of the virtual image because a degree of the generated double image varies depending upon the position of the line of sight of the driver (the image forming position of the virtual image).

Mechanism of occurrence of a double image will be described below. As illustrated in FIG. 6, with respect to a virtual image that is reflected and then viewed and recognized by the driver at an upper portion of windshield 6, a ray that generates the virtual image described above is obliquely made incident on the windshield 6 due to inclination of the windshield 6. Thus, when a thickness of the windshield 6 is set to t, a reflection position P0 of regular light reflected by a reflecting surface near the driver (hereinafter, referred to as a “reflecting surface 1 (or first reflecting surface)”) and a reflection position P1 of back surface reflected light reflected by a reflecting surface far from the driver (hereinafter, referred to as a “reflecting surface 2 (or second reflecting surface)”) are shifted upward to each other by a distance Lin the vertical direction, whereby two virtual images are formed.

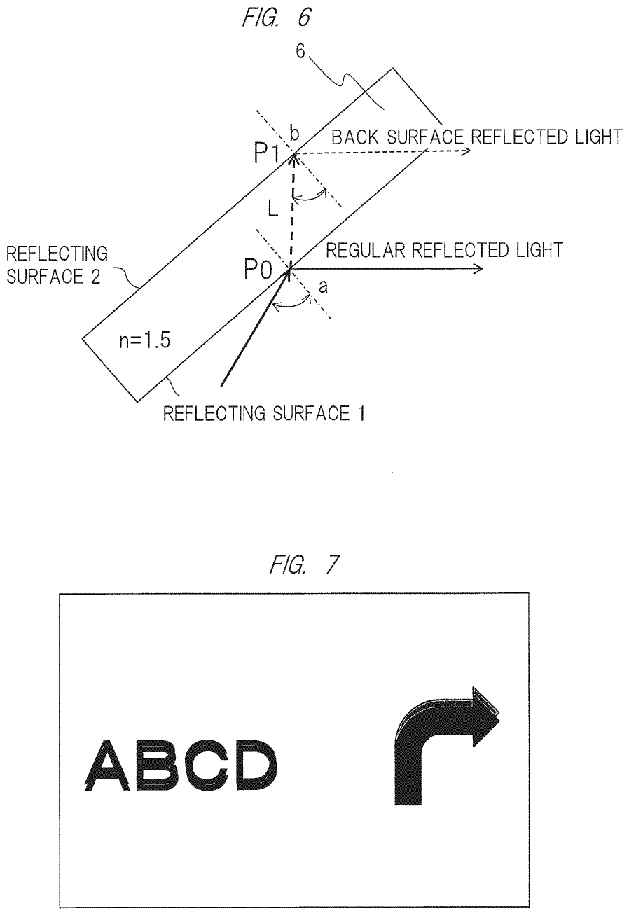

As a result, as illustrated in FIG. 7, in video viewed by the driver, a virtual image based on regular light and a virtual image generated by light reflected by a back surface are viewed so as to overlap with each other up and down. The cause of this will be described in detail below.

Here, for convenience of explanation, a case where video light is natural light in which P wave and S wave are mixed will be described. A reflection factor of light incident on the windshield entered from the air is 4%, and a reflection factor by an interface between the windshield and the air is 4%. They are the same. In a regular virtual image by the regular light and a second virtual image by the back surface reflected light, brightness by the regular virtual image is nearly equal to brightness by the second virtual image by the back surface reflected light. For this reason, reduction of brightness of the virtual image by the back surface reflected light becomes absolutely necessary in order to obtain good resolution performance of video by the virtual image.

The line of sight of the driver is directed downward with respect to a virtual image reflected at a lower portion of a windshield and visually recognized by the driver of video light that forms a virtual image. Therefore, since the ray that generates the virtual image described above is more obliquely made incident on the windshield due to inclination of the windshield compared with the upper portion of the windshield, a shift amount between the back surface reflected light and the regular reflected light up and down becomes larger.

Moreover, in the horizontal direction of the screen, the back surface reflected light is shifted in a direction away from a point at which the optical axis of the concave mirror crosses the windshield with respect to the regular reflected light, whereby two virtual images are formed.

In a case where a refractive index of the windshield is set to 1.5 as descried above, a relationship between an incident angle of a video light ray to the windshield and a reflection factor becomes a relationship so that in case of vertical incidence, both reflection factors with respect to S-polarized light and P-polarized light are about 4%. However, when the incident angle exceeds 25°, the reflection factor with respect to the S-polarized wave becomes larger.

For this reason, in a case where an LCD is used as the video display apparatus, the reflection factor of the windshield varies depending upon which polarized light is used as video output light. Thus, there is a possibility that brightness of the virtual image, which the driver can view and recognize, may vary depending upon the incident angle to the reflecting surface.

Moreover, when a distance between the windshield and the concave mirror is not changed and a region that the driver can view and recognize the virtual image is enlarged, an angle of the video light ray incident on the windshield becomes larger, and double images are generated in the vertical direction and the horizontal direction of the screen. This interferes with a focus feeling of the virtual image.

For this reason, the inventors found that it is further better to reduce distortion aberration occurring due to this by inclining the video display apparatus 4 with respect to the optical axis of the concave mirror 1 to substantially match image magnification M′=b′/a′ of an upper end portion of the virtual image with image magnification M=b/a of a lower end portion of the virtual image.

Moreover, by setting an average radius of curvature of a cross-sectional shape of the optical element 2 in a vertical direction and an average radius of curvature of a cross-sectional shape in a horizontal direction to different values, distortion aberration occurring by an optical path difference that occurs due to a difference between the radius of curvature Rv in the vertical direction and the radius of curvature Rh in the horizontal direction of the windshield described above and aberration that deteriorates the image forming performance of the virtual image are corrected.

As mentioned above, in the information display apparatus 100 that obtains a virtual image by directly reflecting video light to the windshield 6, correction of aberration occurring by the optical path difference that occurs due to the difference between the radius of curvature Rv in the vertical direction and the radius of curvature Rh in the horizontal direction of the windshield 6 becomes the most important for securement of the image forming performance of the virtual image.

For this reason, the inventors reduced deterioration of the image forming performance of the virtual image due to the difference between the radii of curvature of the windshield described above by using a free-form surface shape (see Formula 1 below) capable of defining a shape of a surface as a function of an absolute coordinate (x, y) from the optical axis against an aspherical shape (see Formula 2 below), which has been used in a conventional optical design, to define a shape of a lens surface or mirror surface as a function of the distance r from the optical axis.

$$Z = \frac{c \cdot ( {x}^{2} + {y}^{2} )}{1 + \sqrt{1 - ( 1 + K ) {c}^{2} \cdot ( {x}^{2} + {y}^{2} )}} + \sum \sum ( {C}_{j} ( m , n ) \times {x}^{m} \times {y}^{n} ) \\ j = [ {( m + n )}^{2} + m + 3 n ] / 2 + 1 \qquad [ Formula 1 ]$$

Note that the aspherical shape to define the shape of the lens surface or mirror surface is expressed as a function of the distance r from the optical axis like Formula 2 below.

$$Z = \frac{c \cdot {h}^{2}}{1 + \sqrt{1 - ( 1 + K ) {c}^{2} \cdot {h}^{2}}} + A \times {h}^{4} + B \times {h}^{6} + C \times {h}^{8} + D \times {h}^{10} + E \times {h}^{12} + F \times {h}^{14} + G \times {h}^{16} + H \times {h}^{18} + J \times {h}^{20} \qquad [ Formula 2 ]$$

A refractive index of a windshield for a vehicle is generally 1.5 (n=1.5), and a reflection factor per one surface thereof is 5%. As described above, the information display apparatus 100 causes a virtual image to be reflected by the windshield to form video in the EyeBox of the driver. For this reason, a video light ray is separated into regular reflected light reflected by the reflecting surface 1 positioned at an internal side of the vehicle of windshield 6 and back surface reflected light reflected by the reflecting surface 2 that is in contact with the outside air. It is recognized as a double image by eyes of the driver. A direction in which this double image is generated is different between the vertical direction and the horizontal direction of the windshield 6. In a case where the information display apparatus 100 is arranged under the windshield 6, a double image that is generated by the back surface reflected light is generated at an upper portion of video by the regular reflected light as illustrated in FIG. 7. Similarly, even in a case where the information display apparatus 100 is arranged above the windshield, a double image generated by the back surface reflected light is generated at the upper portion of the video by the regular reflected light.

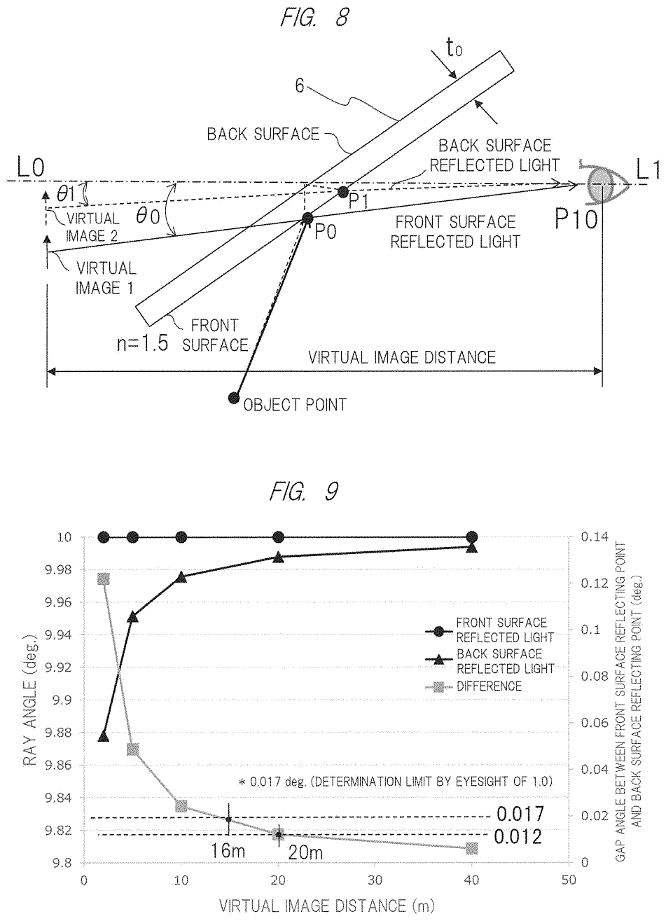

FIG. 8 illustrates the relationship described above. Namely, when an angle of a position, at which a virtual image is displayed, with respect to a horizontal line between L1 and L0 is set to an angle of dip, a virtual image 1 due to light reflected by a front surface of the windshield 6 having a general structure is formed at a position of a ray angle θ0 from an eye P10 of a driver (that is, a viewpoint), and a virtual image 2 due to light reflected by a back surface thereof is formed at a position of a ray angle θ1.

Note that each of these ray angles θ0 and θ1 changes depending upon a virtual image distance from the eye P10 of the driver (that is, a line of sight), which is the position where the virtual images 1 and 2 are formed. Namely, as illustrated in FIG. 9, in a case where the ray angle θ0 of the light reflected by the front surface is set to be constant (see a straight line indicated by “●” in FIG. 9) and the virtual image distance from the eye P10 of the driver (the viewpoint) is small, as a curved line indicated by “▴” in FIG. 9, the ray angle θ1 of the light reflected by the back surface is largely apart from the ray angle θ0 of the light reflected by the front surface (the double image conversion becomes larger). Further, in this case, as the virtual image distance increases, the ray angle θ1 of the light reflected by the back surface gradually approaches the ray angle θ0 (the double image conversion becomes smaller). As a result, with respect to a gap angle between a front surface reflecting point and a back surface reflecting point, which is a difference between these ray angles, as a curved line indicated by “▪” in FIG. 9, a gap of a double image (double image conversion) formed by the virtual image 1 due to the light reflected by the front surface and the virtual image 2 due to the light reflected by the back surface is large in a case where the virtual image distance from the line of sight P10 is small (or close). However, the gap of the double image (the double image conversion) becomes smaller as the virtual image distance becomes longer (or farther). In particular, when the virtual image distance exceeds 16 m, the gap angle between the front surface reflecting point and the back surface reflecting point becomes 0.017 (deg.). When the virtual image distance is 20 m, the gap angle between the front surface reflecting point and the back surface reflecting point becomes 0.012 (deg.). Note that when the virtual image distance is 16 m, the gap angle between the front surface reflecting point and the back surface reflecting point is 0.017 (deg.), and this is a limit (a determination limit range of a normal human (that is, a driver)) at which a human with eyesight of 1.0 can determine the double image formed by the light reflected by the front surface and the light reflected by the back surface.

Therefore, in the present invention, it was found that double image conversion of a virtual image generated by reflecting a video light flux by means of a front surface and a back surface of a windshield can be reduced to a level at which there is no practical problem to form video obtained by causing the virtual image to be reflected by a general windshield and connect the video in the EyeBox of the driver by using the limit (the determination limit range of the normal human (the driver)), at which the double image described above can be determined, while adopting a general windshield. As a result, an information display apparatus with a small size has been achieved that forms virtual images at a plurality of positions corresponding to a viewpoint position of the driver.

Namely, a video light ray of the HUD, which is emitted and reflected from the video display apparatus 4 of the information display apparatus 100 described above toward the general windshield 6 via the concave mirror 1 to enter the eye P10 of the driver (the line of sight), is set so that the virtual image distance exceeds the determination limit range of the normal human from the eye P10 of the driver (the viewpoint), for example, exceeds 16 m or 20 m from the viewpoint P10 or the virtual image is formed in a visual field distance region around the viewpoint P10. This makes it possible to reduce the double image conversion described above of the virtual image to the level at which there is no practical problem and resolve the double image conversion. Note that according to various experiments by the inventors, as a more specific example, it became clear that it is preferable that this determination limit range of the normal human is set to 16 m or longer from the eye P10 of the driver (the viewpoint) and it is more preferable that it is set to a range from 30 m to 200 m.

Note that it is possible to easily detect a position of the eye P10 of the driver (the viewpoint), which is important to set a ray angle θ, by using an image of the driver from the camera 77, which is inputted into the driver monitoring system 64 constituting the whole system of the information display apparatus illustrated in FIG. 1 described above. Further, it is clear for those skilled in the art that adjustment by a change in the position of the eye P10 of the driver (the viewpoint), such as a change in an inclination angle of the video display apparatus 4 with respect to the optical axis of the concave mirror 1 based on the detected position of the eye P10 of the driver (the viewpoint) or a change in a position of an HUD information image on the video display apparatus 4, can be realized easily and automatically according to the controller 40 and the like described above. In addition, it can be configured so that a display position of the HUD information image can be changed in accordance with the eyesight of the driver by inputting the eyesight of the driver in advance or at any time. Further, the thickness of the windshield is generally about 5 mm±1 mm at the center. As the thickness increases, a shift amount of the double image also increases. Further, the inventors also paid attention to variation in the thickness of the windshield. In particular, the inventors confirmed that by experiments, in a case where a difference between thicknesses of an upper end and a lower end of the windshield varies and a thickness Td of the lower end is smaller than a thickness Tu of the upper end, the shift amount of the double image becomes smaller, and thus, not only an average thickness thereof but also variation between the thicknesses of the upper and lower ends or right and left ends greatly influences on an absolute value of the shift amount of the double image with respect to management of the thickness of the windshield. In addition, the inventors found that it is more preferable to adopt a windshield in which the thickness Tu of the upper end is thicker than the thickness Td of the lower end (Tu>Td).

As described above, it has mentioned that the radius of curvature of a glass surface at the driver's side of the windshield, which is in contact with the outside world, is the same (a parallel plate) in a portion at which the light flux forming the virtual image is reflected. However, as a result that the radii of curvature at upper and lower portions are actually different from each other and thicknesses of the windshield at the upper and lower portions are different from each other, a double image is generated. It became clear that it is desirable that an angle difference generated due to this difference between the thicknesses is 0.003 degree or lower in a range of 30 m to 50 m from the eye P10 of the driver (the viewpoint), and that the angle difference is 0.005 degree or lower in a range of 50 m to 200 m.

Moreover, in the embodiment described above, the general windshield in which the thickness (cross section) is uniform has been mentioned as a preferable example of the projected member 6 described above. However, the present invention is not limited to this, and can be applied to a windshield whose cross section is a wedge shape (that is, a thickness thereof varies in a vertical height direction thereof). Moreover, although the effect thereof is limited, the present invention can easily be applied to a windshield in which an interlayer whose cross section is a wedge shape is formed between two sheets of glass according to the conventional technique described above. Note that in that case, the important ray angle θ particularly varies due to the position (in the height direction) of the eye P10 of the driver (the viewpoint) with respect to the windshield whose cross section is the wedge shape. From this fact, it is preferable that the position of the viewpoint P10 is confirmed by using the image of the driver obtained from the camera of the driver monitoring system 64 described above by means of the controller 40 or the like, and the distance region where HUD video light forms the virtual image is adjusted. Note that more specifically, it is preferable that the display position of the HUD information on the video display apparatus 4 is adjusted on the basis of the position of the viewpoint P10.

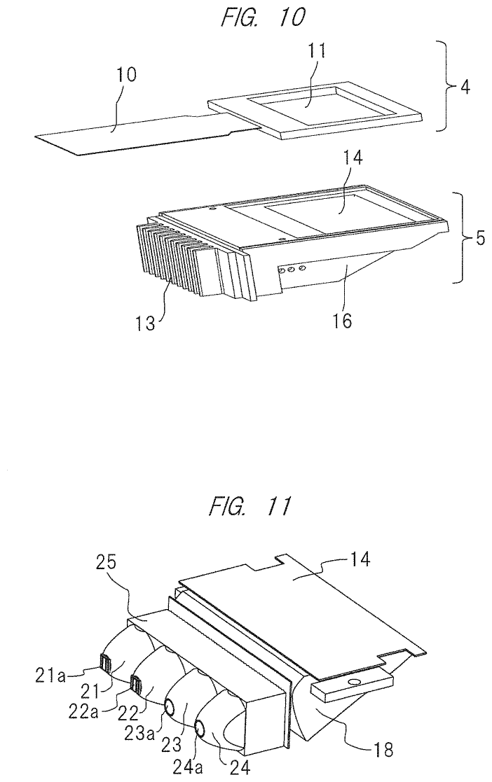

Next, another configuration according to the embodiment of the present invention for allowing the double image described above to be reduced and allowing a virtual image with high visibility to be formed will be described in detail with reference to FIG. 10 to FIG. 15. FIG. 10 is an enlarged view of a main portion of the liquid crystal panel and the backlight 5 as the video display apparatus 4 in the virtual image optical system according to the embodiment described above. By modulating light from the backlight by a video signal inputted from a flexible board 10 of the liquid crystal panel, video is displayed on a liquid crystal panel display surface 11, and a virtual image is generated from the displayed video by the virtual image optical system (including a free-form surface concave mirror and a free-form surface optical element in the embodiment) to inform the driver of video information.

In the configuration described above, an LED light source with relatively inexpensive and high reliability as a solid light source is used for a light source element of the backlight 5. A surface emission type of LED is used for high output. Therefore, light utilization efficiency is improved by using technical ingenuity (will be described later). Emission efficiency of the LED with respect to input electric power is different depending upon emission color, and is about 20% to 30%. The remaining is almost converted into heat. For this reason, as a frame to attach the LED, by providing a fin 13 for heat radiation configured by a member with high thermal conductivity (for example, a metallic member such as aluminum) to radiate heat to the outside, an effect to improve the emission efficiency of the LED itself can be obtained.

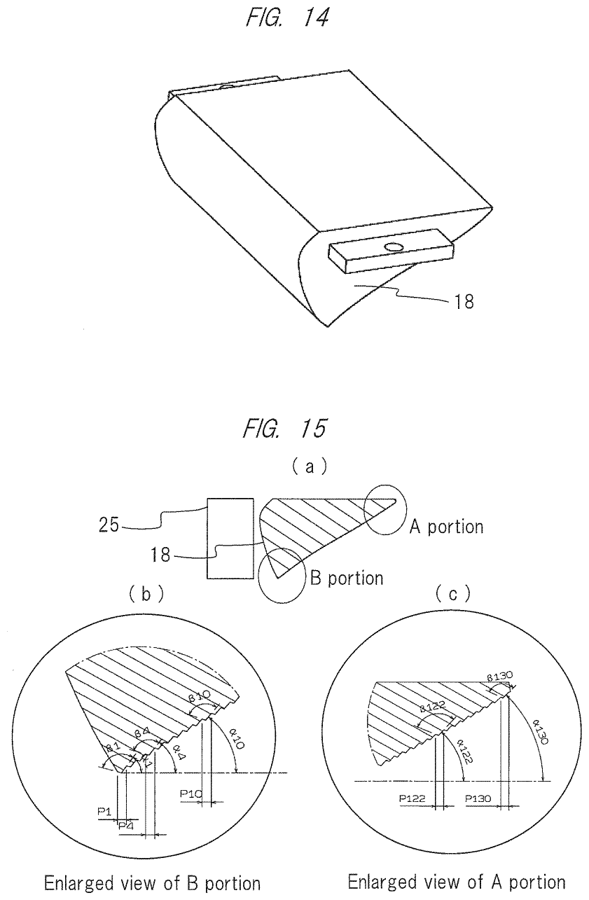

In particular, emission efficiency of an LED using red as emission color, which currently goes on the market, is significantly deteriorated when junction temperature becomes higher, and chromaticity of video changes at the same time. Thus, it is preferable that the light source element is configured so that priority to reduce temperature of the LED is raised and an area of the corresponding radiation fin becomes larger to improve cooling efficiency. In order to guide light diffused from the LED to the liquid crystal panel 4 efficiently, a light guide element 18 is used in the example illustrated in FIG. 14 and FIG. 15. However, it is preferable that the whole is covered by an exterior member 16 to unify the backlight light source so that dust or the like does not adhere thereto, for example.

Further, FIG. 11 illustrates an enlarged view of a main part of a light source unit including an LED that is a light source, a light guide element and a diffused plate. As is apparent from FIG. 11, by inserting a medium between the LEDs to optically connect openings 21a, 22a, 23a, 24a that take in divergent light rays from LEDs of light funnels 21, 22, 23, and 24 to each other as a plane or by having a focusing action as a convex shape to cause the light source light to be diverged to become parallel light as much as possible, an incident angle of light made incident on a boundary surface of the light funnel is made smaller. As a result, the divergent angle can further be made smaller after passing through the light funnel. Therefore, control of the light source light directed to the liquid crystal panel after being reflected by the light guide element 18 can be facilitated.

Moreover, in order to improve utilization efficiency of divergent light from the LED, polarization conversion is carried out for a joining portion 25 between the light funnels 21 to 24 and the light guide element 18 by using a PBS (Polarizing Beam Splitter) to convert that of the light to a desired polarization direction, whereby it is possible to improve efficiency of incident light to the LCD.

As described above, in a case where the polarization direction of light source light is uniformed, it is further preferable that material with low birefringence is used as raw material of the light guide element 18 so that problems such as coloring at the time of black display does not occur, for example, when a direction of the polarized wave is rotated and the polarized wave passes through the liquid crystal panel.

As mentioned above, the light flux from the LED whose divergent angle is reduced is controlled by the light guide element; is reflected by a totally reflecting surface that is provided an inclined surface of the light guide element 18; is diffused by a diffusing member 14 arranged between an opposing surface and the liquid crystal panel; and is then made incident on the liquid crystal panel as the video display apparatus 4. In the present embodiment, as described above, the diffusing member 14 is arranged between the light guide element 18 and the liquid crystal panel 4. However, the similar effect can be obtained even though a diffusing effect is caused to have an end surface of the light guide element 18 to provide a fine uneven shape, for example.

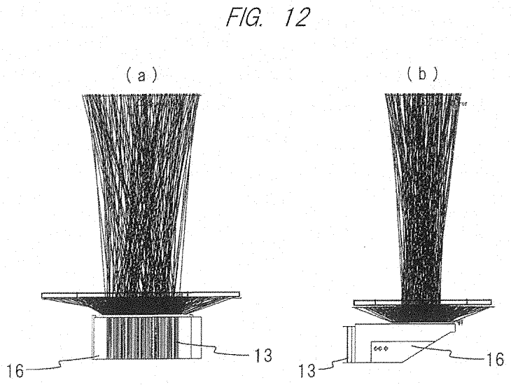

Next, FIG. 12 illustrates a result obtained by simulating a state where emission light from the backlight described above passes through the liquid crystal panel in the information display apparatus 100 according to the present embodiment with respect to a configuration of the light guide element 18 described above and effects obtained by the configuration. FIG. 12(a) is a view illustrating an emission state of light when viewed from a longitudinal direction of the liquid crystal panel. FIG. 12(b) is a view illustrating an emission state of light when viewed from a short side direction (that is, a direction perpendicular to the longitudinal direction thereof) of the liquid crystal panel. In the present embodiment, the horizontal angle of the FOV is widened more than its design. Therefore, it is designed that brightness of the virtual image viewed and recognized by right and left eyes is not changed extremely even in a case where a diffusion angle in a horizontal direction is enlarged with respect to that in a vertical direction and a position of eyes is moved by rotation of the driver's head.

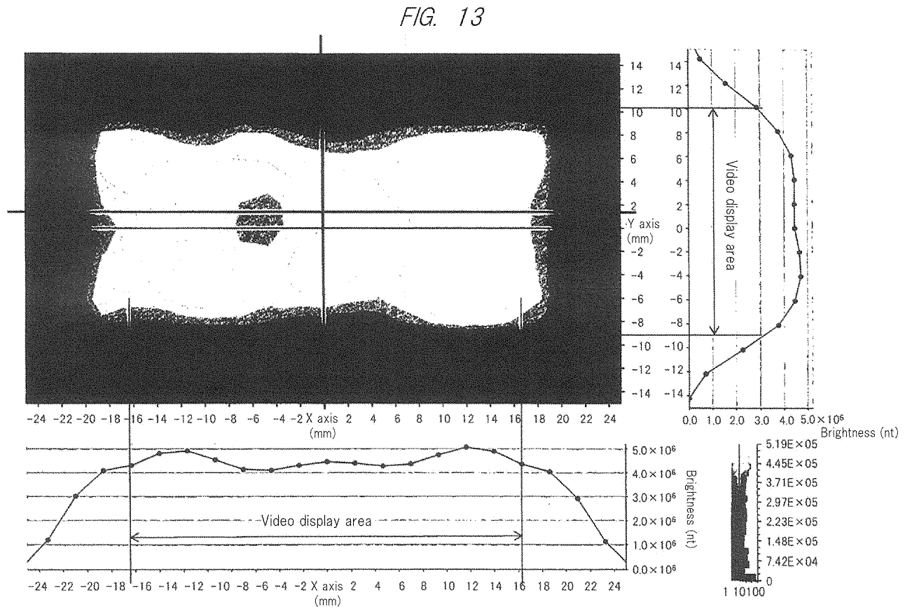

Further, by making a divergent angle of the backlight in the vertical direction smaller, a divergent angle of video displayed on the liquid crystal panel in a vertical direction of the screen is made smaller, whereby generation of a double image is suppressed. FIG. 13 illustrates brightness distribution of the emission surface of the liquid crystal panel 4 in case of using the backlight by controlling an emission direction and intensity of light by using the light guide element 18 like the present embodiment. As is apparent from FIG. 13, inclination of deterioration of brightness outside an effective range of the vertical direction (long side direction) of the screen can be made smaller in addition to the brightness distribution of the vertical direction (short side direction) of the screen.

The emission light (video light) from the liquid crystal panel that is used as the video display apparatus in the information display apparatus 100 according to the present embodiment indicates predetermined transmittance in a range of ±50° in a case where visual angles in horizontal and vertical directions are used as a parameter. In a case where a range of the visual angle falls within ±40°, it is possible to obtain a better transmittance characteristic. As a result, as illustrated in FIG. 12 and FIG. 13, brightness of the screen greatly varies depending upon a direction to view the screen (visual angle) in the horizontal direction and the vertical direction of a display screen. This is caused by an angular characteristic of backlight brightness.

For this reason, the inventors obtained high brightness by controlling the angle of the totally reflecting surface of the light guide element 18 and the divergent angle of the light source light from the LEDs of the light funnels 21 to 24 to narrow visual angle property of the backlight into a small range so that the emission light from the liquid crystal panel 4, which is taken in the virtual image optical system, can be obtained as light vertical to the screen as much as possible. Specifically, in order to obtain video with high brightness, light in a range of ±30° in a right-and-left viewing angle is used, and contrast performance is considered. By narrowing it to ±20° or smaller, the virtual image using a source image with good image quality could be obtained at the same time.

As mentioned above, the contrast performance that influences the image quality of the video display apparatus is determined by to what extent brightness when black as a basis to determine image quality is displayed can be lowered. For this reason, it is preferable that an iodine-based polarizing plate in which the degree of polarization is high is used between the liquid crystal panel 4 and the backlight.

On the other hand, by using a dye-based polarizing plate as a polarizing plate provided at the optical element 2 side (light emission surface), it is possible to obtain high reliability even in a case where outside light enters therein or ambient temperature is high.

In a case where color display is executed in the liquid crystal panel 4, color filters corresponding to the respective pixels are provided. For this reason, in a case where light source color of the backlight is white, light absorption with the color filters becomes greater, and loss thereof becomes larger. Thus, the inventors use a plurality of LEDs:

(1) to add a green LED whose contribution to brightness is large compared with the case where a plurality of white LEDs is used.
(2) to add a red or blue LED to the white LED to improve glossy property of an image.
(3) to individually arrange red, blue, and green LEDs, add a green LED whose contribution to brightness is large, and individually drive the LEDs, thereby enlarging a color reproduction range to heighten glossy property as well as to improve brightness.
(4) to raise transmittance of each color filter with respect to peak brightness of red, blue, green LEDs by implementing the above (3) to improve brightness as a whole.
(5) to reduce damage of the polarizing plate at an incident side of the liquid crystal panel as a second embodiment of the backlight by arranging the PBS between the light funnels and the light guide element to uniform it to a specific polarized wave.
It goes without saying that a polarization direction of the polarizing plate that is arranged at the incident side of the liquid crystal panel may be a direction through which the polarized wave uniformed to a specific direction after passing through the PBS passes.

As mentioned above, as the video display apparatus 4 according to the embodiment of the present invention, a λ/4 plate can be provided on the emission surface of the liquid-crystal display panel to convert the emission light to circular polarized light. As a result, the driver is allowed to monitor a good virtual image even though he or she wears polarized sunglasses.

Moreover, by forming reflection coating for the reflecting mirror used in the virtual image optical system by metallic multilayer, angular dependence of reflection power is small, and the reflection power is never changed by a polarization direction (a P wave or S wave). Therefore, it becomes possible to uniformly keep chromaticity and brightness of the screen.

Moreover, in a case where an ultraviolet ray reflecting film or an optical member obtained by combining the ultraviolet ray reflecting film and an infrared ray reflecting film is provided between the virtual image optical system and the windshield, temperature rise of the liquid-crystal display panel and the polarizing plate and damage therefrom can be reduced even though outside light (solar light) enters it. Therefore, an effect that reliability of the information display apparatus 100 is not impaired can be obtained.

Further, in the virtual image optical system, optimum design including a difference between the radius of curvature in the horizontal direction and the radius of curvature in the vertical direction of the windshield that is the projected member in the conventional technique in the vehicle is carried out. The concave mirror 1 whose concave surface faces the windshield 6 side is arranged between the windshield 6 and the video display apparatus 4 or an intermediate image display unit. This causes video of the video display apparatus 4 to be enlarged, and the video is reflected by the windshield 6. At this time, the optical element is arranged between the concave mirror 1 described above and the video display apparatus 4. On the other hand, video light flux to form an enlarged image (virtual image) of the video, which is formed in accordance with a viewpoint position of the driver, passes through the optical element arranged between the concave mirror 1 and the video display apparatus 4, thereby correcting distortion and/or aberration that occurs in the concave mirror 1. For that reason, a virtual image in which distortion and aberration are reduced significantly can be obtained compared with the virtual image optical system including only the conventional concave mirror.

As mentioned above, according to the present invention, by optimizing the shape and the position of the optical element in accordance with the video light flux that establishes the respective virtual images separated between the display and the concave mirror and making it possible to reduce the double image conversion of the virtual image, which is generated by reflecting the video light flux by means of the front surface and the back surface of the windshield, to the level at which there is no practical problem while adopting the general windshield, it becomes possible to provide the information display apparatus that respectively forms a plurality of virtual images at a plurality of positions in accordance with the viewpoint position of the driver while maintaining a small size.

As described above, the sheet-like light source apparatus suitable to be used for an electronic apparatus provided with the image display device according to various embodiments of the present invention has been described. However, the present invention is not limited to the embodiments described above, and various modifications are contained. For example, the whole system has been explained in detail in the embodiments described above for explaining the present invention clearly. The present invention is not necessarily limited to one that includes all configurations that have been explained. Further, a part of the configuration of one embodiment can be replaced by a configuration of the other embodiment. Further, a configuration of the other embodiment can be added to a configuration of one embodiment. Moreover, a part of the configuration of each of the embodiments can be added to the other configuration, deleted or replaced thereby.

### REFERENCE SINGS LIST

100 . . . information display apparatus, 101 . . . vehicle, 1 . . . concave mirror, 2 . . . optical element, 4 . . . video display apparatus, 5 . . . backlight, 6 . . . projected member (windshield), 7 . . . housing, V1 . . . virtual image, 8 . . . EyeBox (eyes of observer).

1. An information display apparatus configured to display video information of a virtual image on a windshield of conveyance, the information display apparatus comprising:
a display configured to display the video information; and
a virtual image optical system configured to display a virtual image at a front of the conveyance by reflecting light emitted from the display by means of the windshield,
wherein the virtual image optical system includes a concave mirror and an optical element,
wherein the optical element is arranged between the display and the concave mirror, and is configured to correct distortion of the virtual image obtained in accordance with a viewpoint position of a driver on a basis of a shape of the concave mirror and a shape of the optical element, and
wherein the information display apparatus further comprises means for forming the virtual image generated by reflecting a video light flux by means of a front surface and a back surface of the windshield in front of a position of a line of sight of the driver in a region in which a virtual image distance exceeds a determination limit range of the driver or a visual field distance region around the determination limit range.

2. The information display apparatus according to claim 1,
wherein the determination limit range is 16 m or longer.

3. The information display apparatus according to claim 1,
wherein the windshield is any of a windshield that does not include a wedge-shaped interlayer, a windshield that does not include a wedge-shaped interlayer and whose cross section is a wedge shape, and a windshield in which an interlayer whose cross section is a wedge shape is formed between two sheets of glass.

4. The information display apparatus according to claim 1,
wherein the windshield is a general windshield that does not include an interlayer or a windshield that does not include an interlayer and whose cross section is a wedge shape.

5. The information display apparatus according to claim 3,
wherein the windshield whose cross section is the wedge shape is a windshield in which a thickness of an upper end thereof is thicker than a thickness of a lower end thereof.

6. The information display apparatus according to claim 1, further comprising:
means for detecting a viewpoint position of the driver; and
means for adjusting the determination limit range in which the video information of the virtual image is to be displayed on a basis of the viewpoint position of the driver detected by the detecting means.

7. An information display apparatus configured to display video information of a virtual image on a windshield of conveyance, the information display apparatus comprising:
a display configured to display the video information; and
a virtual image optical system configured to display a virtual image at a front of the conveyance by reflecting light emitted from the display by means of the windshield,
wherein the virtual image optical system includes a concave mirror and an optical element,
wherein the optical element is arranged between the display and the concave mirror, and is configured to correct distortion of the virtual image obtained in accordance with a viewpoint position of a driver on a basis of a shape of the concave mirror and a shape of the optical element, and
wherein the display and the virtual image optical system are arranged so that an angle difference between a reflection angle θ1 at which a video light flux is reflected by a front surface of the windshield and a refraction angle θ2 at which a video light flux is refracted by the front surface of the windshield after reflection by a back surface becomes 0.017 degree or lower.

8. The information display apparatus according to claim 7,
wherein the display and the virtual image optical system are arranged so that the angle difference becomes 0.003 degree or lower.

9. An information displaying method for an information display apparatus configured to display video information of a virtual image on a windshield of conveyance, the information display apparatus comprising:
a display configured to display the video information; and
a virtual image optical system configured to display a virtual image at a front of the conveyance by reflecting light emitted from the display by means of the windshield,
wherein the virtual image optical system includes a concave mirror and an optical element,
wherein the optical element is arranged between the display and the concave mirror, and is configured to correct distortion of the virtual image obtained in accordance with a viewpoint position of a driver on a basis of a shape of the concave mirror and a shape of the optical element, and
the method comprising:
forming the virtual image generated by reflecting a video light flux by means of a front surface and a back surface of the windshield in front of a position of a line of sight of the driver in a region in which a virtual image distance that exceeds a determination limit range of the driver or a visual field distance region around the determination limit range.

10. The information displaying method according to claim 9,
wherein the determination limit range is set to a range from 16 m to 200 m.

11. The information displaying method according to claim 9,
wherein any of a windshield that does not include a wedge-shaped interlayer, a windshield that does not include a wedge-shaped interlayer and whose cross section is a wedge shape, and a windshield in which an interlayer whose cross section is a wedge shape is formed between two sheets of glass is adopted as the windshield.

12. The information displaying method according to claim 9,
wherein any of a windshield that does not include an interlayer and a windshield that does not include an interlayer and whose cross section is a wedge shape is adopted as the windshield.

13. The information displaying method according to claim 11,
wherein the windshield whose cross section is the wedge shape is a windshield in which a thickness of an upper end thereof is thicker than a thickness of a lower end thereof.

14. The information displaying method according to claim 9, further comprising:
detecting a viewpoint position of the driver; and
adjusting the determination limit range in which the video information of the virtual image is to be displayed on a basis of the viewpoint position of the driver detected by the detecting step.

15. The information display apparatus according to claim 4,
wherein the windshield whose cross section is the wedge shape is a windshield in which a thickness of an upper end thereof is thicker than a thickness of a lower end thereof.

16. The information displaying method according to claim 12,
wherein the windshield whose cross section is the wedge shape is a windshield in which a thickness of an upper end thereof is thicker than a thickness of a lower end thereof.
